(19) United States
(12) Patent Application Publication
(10) Pub. No.: US 2026/0075649 A1
(43) Pub. Date: Mar. 12, 2026

(54) CYCLIC PREFIX EXTENSION RAMPING FOR SENSING IN SHARED SIDELINK CHANNEL COMMUNICATIONS

(71) Applicant: QUALCOMM Incorporated, San Diego, CA (US)

(72) Inventors: Kangqi Liu, San Diego, CA (US); Weimin Duan, San Diego, CA (US)

(21) Appl. No.: 18/882,556

(22) Filed: Sep. 11, 2024

(51) Int. Cl. H04W 74/0816; H04W 72/40; H04W 76/18

(52) U.S. Cl. CPC H04W 74/0816; H04W 72/40; H04W 76/18

(57) ABSTRACT

An example user equipment (UE) device for wireless communication includes a communication interface; and one or more processors coupled to the communication interface, wherein the one or more processors are configured to: select a first cyclic prefix extension (CPE) for a transmission over a shared sidelink band via the communication interface; perform a listen before talk (LBT) procedure on the shared sidelink band; in response to the LBT procedure, determine that the shared sidelink band is LBT-blocked; in response to the shared sidelink band being LBT-blocked, select a second CPE larger than the first CPE; and transmit the second CPE and the transmission over the shared sidelink band via the communication interface.

### TECHNICAL FIELD

This disclosure relates to wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some wireless communications systems, such as 4G and 5G systems, may support channel state information (CSI) operations and may also support discontinuous reception (DRX) operations.

As the demand for mobile broadband access continues to increase, research and development continue to advance wireless communication technologies not only to meet the growing demand for mobile broadband access, but to advance and enhance the user experience with mobile communications.

### SUMMARY

In general, this disclosure describes techniques related to sidelink communications between user equipment (UE) devices over shared bands. In 5G networks, sidelink refers to direct communication between UEs, without the use of a base station or other intermediate network device. When communicating via sidelink over an unlicensed spectrum (SL-U) band, UEs are configured to select a cyclic prefix extension (CPE). Using CPEs, UEs can perform a listen before talk (LBT) procedure, by which a UE may determine whether the intended channel is currently in use by another UE (that is, the other UE is currently transmitting on that channel). When two UEs select respective CPEs and schedule transmissions for substantially the same time, the UE that selects the longer CPE will gain priority for access to the channel. However, the CPE transmission consumes resources without including actual intended data for communication, such that UEs are incentivized to avoid selecting the largest possible CPEs. This disclosure describes techniques for modifying the CPE based on, e.g., detecting LBT-blocking or lack thereof. In particular, if LBT-blocking is detected, a UE may increase its CPE, e.g., linearly or non-linearly. By contrast, if LBT-blocking has not been detected for a period of time, the UE may decrease its CPE. Furthermore, the UE may obtain CPE parameters from a sensing server or other UEs, if such are available.

In one example, a user equipment (UE) device for wireless communication includes: a communication interface; and a processing system coupled to the communication interface, wherein the processing system is configured to: select a first cyclic prefix extension (CPE) for a transmission over a shared sidelink band via the communication interface; perform a listen before talk (LBT) procedure on the shared sidelink band; in response to the LBT procedure, determine that the shared sidelink band is LBT-blocked; in response to the shared sidelink band being LBT-blocked, select a second CPE larger than the first CPE; and transmit the second CPE and the transmission over the shared sidelink band via the communication interface.

In another example, a method of wireless communication includes: selecting a first cyclic prefix extension (CPE) for a transmission over a shared sidelink band; performing a listen before talk (LBT) procedure on the shared sidelink band; in response to the LBT procedure, determining that the shared sidelink band is LBT-blocked; in response to the shared sidelink band being LBT-blocked, selecting a second CPE larger than the first CPE; and transmitting the second CPE and the transmission over the shared sidelink band.

In another example, a user equipment (UE) device for wireless communication includes: means for selecting a first cyclic prefix extension (CPE) for a transmission over a shared sidelink band; means for performing a listen before talk (LBT) procedure on the shared sidelink band; means for determining, in response to the LBT procedure, that the shared sidelink band is LBT-blocked; means for selecting, in response to the shared sidelink band being LBT-blocked, a second CPE larger than the first CPE; and means for transmitting the second CPE and the transmission over the shared sidelink band.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a schematic illustration of a wireless communication system according to some aspects of this disclosure.

FIG. 2 is a conceptual illustration of an example of a radio access network according to some aspects of this disclosure.

FIG. 3 is a schematic illustration of a distributed base station in an open radio access network architecture according to some aspects of this disclosure.

FIG. 4 is a block diagram illustrating an example hardware implementation of a base station employing a processing system.

FIG. 5 is a block diagram illustrating an example set of transmission components of a base station.

FIG. 6 is a block diagram illustrating an example hardware implementation of a user equipment (UE) employing a processing system.

FIG. 7 is a flow diagram illustrating example actions performed by a UE for transmitting over a sidelink channel via a shared (unlicensed) band according to various techniques of this disclosure.

FIG. 8 is a conceptual diagram illustrating the use of CPEs to access a sidelink channel on a shared (unlicensed) band.

FIG. 9 is a conceptual diagram illustrating another example use of CPEs to access a sidelink channel on a shared (unlicensed) band.

FIG. 10 is a conceptual diagram illustrating an example CPE ramping procedure per techniques of this disclosure.

FIG. 11 is a conceptual diagram illustrating an example maximum CPE ramping-up size and sensing failure.

### DETAILED DESCRIPTION

Wireless communications systems may include multiple communication devices such as user equipment (UEs) and base stations (e.g., network entities), which may provide wireless communication services to the UEs. For example, such base stations may be next-generation NodeBs or giga-NodeBs (either of which may be referred to as a gNB) that may support multiple radio access technologies (RATs) including fourth generation (4G) systems, such as Long Term Evolution (LTE) systems, as well as fifth generation (5G) systems, which may be referred to as New Radio (NR) systems. Some UEs may support reference signal transmission, reception, and reporting.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node.

In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node.

Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, user equipment (UE) devices may communicate via sidelink (SL) over shared (unlicensed) bands (SL-U), e.g., per 5G Release 18 (Rel-18). In some examples, UEs prepend a cyclic prefix extension (CPE) to a transmission. CPE may be used to fill or reduce inactivity gaps and ease channel access through blocking other radio access technologies (RATs) from accessing the channel. In SL-U, CPE may be used to avoid collisions among UEs attempting to access the channel at the same slot. For some use cases, such as commercial or indoors for which Rel-18 SL-U is considered, physical sidelink shared channel (PSSCH) transmissions are expected to be wideband. Hence, if two or more UEs perform PSSCH transmissions over the same slot, chances are that they will collide. If no reservation has been made (e.g., via SCI-1) for a slot that a UE intends to transmit over, the UE selects a CPE from a set of pre-configured CPEs according to the priority of its transmission in Rel-18. TS 38.211 specifies various example CPE values. A resource pool (RP) may configure a set of valid CPE values from those of TS 38.211. If multiple UEs intend to perform transmissions over the same slot and pick different CPEs, the UE that selects the longest CPE will start its transmission first, listen before talk (LBT) blocking the rest of the UEs, thereby avoiding collision.

This disclosure recognizes that the collision protection offered by the CPE per Rel-18 is on a per-transmission basis. That is, if a transmission of a certain UE is protected by the CPE design, there is no guarantee that the same will happen for its next transmission or for transmissions of other UEs.

According to the techniques of this disclosure, a UE may be configured to use a CPE ramp-based selection scheme. That is, in response to a detected LBT blockage, when a sensing signal (in a periodic sensing signal set) is LBT-blocked, the UE may trigger CPE ramp up for the next sensing signal transmission occasion. The step size for the CPE ramp up may be linear or non-linear. For example, when the sensing signal gets LBT-blocked consecutively, the UE may continually increase the CPE step size. These techniques may be applied to a default CPE and/or to a previously ramped CPE.

Likewise, per these techniques, the UE may ramp down when LBT blockage does not occur for a period of time. For example, when a sensing signal with CPE ramping is transmitted without being LBT-blocked consecutively for some threshold number of times, the UE may trigger CPE ramp down for the next sensing signal transmission occasion. The CPE ramp down step size may be linear or non-linear. Likewise, the CPE ramp down step size may be the same as or different than the CPE ramp up step size. When a sensing signal with CPE ramping is transmitted without being LBT-blocked consecutively for a period of time (e.g., for a threshold number of times), the UE may use the default CPE for the next sensing signal transmission occasion, instead of ramping down gradually.

In some examples, the UE may receive the CPE parameters (e.g., CPE ramp up size, CPE ramp down size, maximum CPE ramping size, threshold values, or the like) from a sensing server and/or from other UEs using the channel.

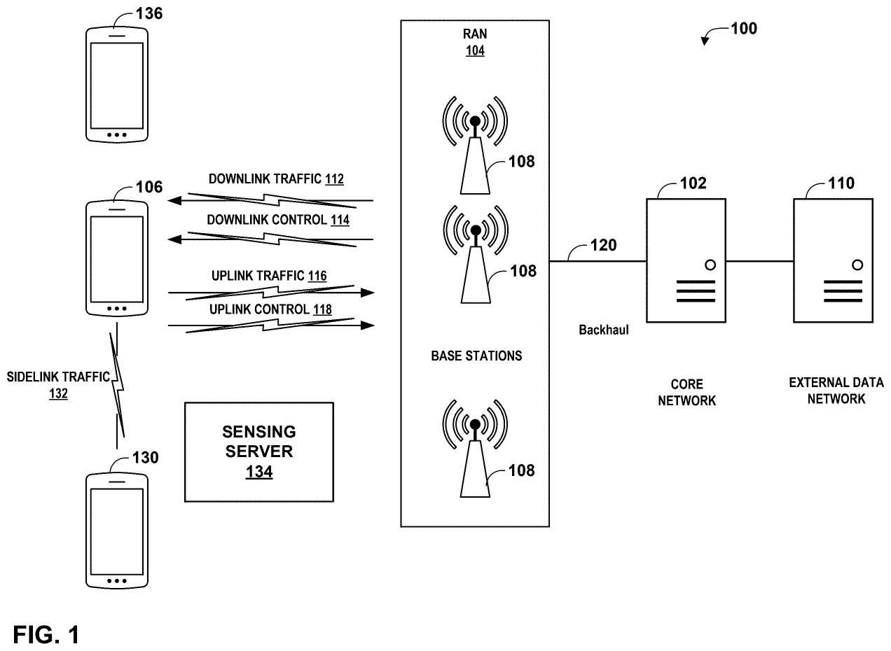

FIG. 1 is a block diagram illustrating an example wireless communication system 100 that may be configured to perform techniques of this disclosure. Wireless communication system 100 includes several interacting domains: core network 102, radio access network (RAN) 104, and user equipment (UE) 106. By virtue of wireless communication system 100, UE 106 may be enabled to carry out data communication with external data network 110, such as (but not limited to) the Internet.

RAN 104 may implement any suitable wireless communication technology or technologies to provide radio access to the UE 106. As one example, RAN 104 may operate according to 3rd Generation Partnership Project (3GPP) New Radio (NR) specifications, often referred to as 5G or 5G NR. In some examples, RAN 104 may operate under a hybrid of 5G NR and Evolved Universal Terrestrial Radio Access Network (eUTRAN) standards, often referred to as Long Term Evolution (LTE). 3GPP refers to this hybrid RAN as a next-generation RAN, or NG-RAN. Of course, many other examples may be utilized within the scope of the present disclosure.

As illustrated, RAN 104 includes a plurality of base stations 108. Broadly, a base station is a network element in a radio access network responsible for radio transmission and reception in one or more cells to or from a UE, such as UE 106. In different technologies, standards, or contexts, a base station may be referred to as a base transceiver station (BTS), a radio base station, a radio transceiver, a transceiver function, a basic service set (BSS), an extended service set (ESS), an access point (AP), a Node B (NB), an evolved Node B (eNB), a gNode B (gNB), a 5G NB, a serving cell, or other suitable terminology.

RAN 104 supports wireless communication for multiple mobile apparatuses, including UE 106. A mobile apparatus may be referred to as a UE, as in 3GPP specifications, or as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices, such as smart phones/cellular telephones.

A mobile apparatus (aka a UE) need not necessarily have a capability to move, and need not be stationary. The term “mobile apparatus” or “mobile device” broadly refers to a diverse array of devices and technologies. UEs may include a number of hardware structural components sized, shaped, and arranged to help in communication. Such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; and agricultural equipment; etc.

Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data. A mobile apparatus may additionally include two or more disaggregated devices in communication with one another, including, for example, a wearable device, a haptic sensor, a limb movement sensor, an eye movement sensor, etc., paired with a smartphone. In various examples, such disaggregated devices may communicate directly with one another over any suitable communication channel or interface, or may indirectly communicate with one another over a network (e.g., a local area network or LAN).

As illustrated in FIG. 1, base stations 108 may broadcast downlink traffic 112 to one or more UEs, such as UE 106. Broadly, base stations 108 are network nodes or devices responsible for scheduling traffic in a wireless communication network, including downlink traffic 112 and, in some examples, uplink traffic 116 from one or more UEs, such as UE 106, to base stations 108. On the other hand, UE 106 is a network node or device that receives downlink control information 114, including but not limited to scheduling information (e.g., a grant), synchronization or timing information, or other control information from another entity in the wireless communication network, such as base stations 108.

In general, base stations 108 may include a backhaul interface for communication with backhaul portion 120 of wireless communication system 100. Backhaul 120 may provide a link between base stations 108 and core network 102. Further, in some examples, a backhaul network may provide interconnection between base stations 108. Various types of backhaul interfaces may be employed, such as a direct physical connection, a virtual network, or the like, using any suitable transport network.

Core network 102 may be a part of wireless communication system 100, and may be independent of the radio access technology used in RAN 104. In some examples, core network 102 may be configured according to 5G standards (e.g., 5GC). In other examples, core network 102 may be configured according to a 4G evolved packet core (EPC), or any other suitable standard or configuration.

In addition or in the alternative to downlink traffic 112 and uplink traffic 116, UE 106 may communicate with UE 130 using sidelink traffic 132. Sidelink traffic 132 may be carried via an unlicensed (that is, shared) band. Thus, before transmitting data to UE 130, for example, UE 106 may select a cyclic prefix extension (CPE) for the transmission. The CPE may be a default CPE or be based on a priority for the transmission. UE 106 may then perform a listen before talk (LBT) procedure on the shared band to determine whether another UE (e.g., UE 136) is currently transmitting on the band.

Per techniques of this disclosure, if UE 106 determines that the band is LBT-blocked, UE 106 may increase the CPE for a subsequent attempt at scheduling the transmission. The increase may be a linear step size a non-linear step size. UE 106 may continually increase the CPE for each consecutive LBT-blocking instance, until either reaching a maximum CPE size or until a consecutive number of LBT blocking instances exceeds a threshold. After the number of LBT blocking instances exceeds a threshold, UE 106 may wait for a period of time until attempting the transmission again, or may switch to a different band.

Likewise, after having increased the CPE size and then successfully performing one or more transmissions, UE 106 may be configured to ramp down the CPE size. For example, UE 106 may be configured with a threshold number of consecutive transmissions without being LBT-blocked, after which UE 106 may decrease the CPE size. The CPE step down size may be linear or non-linear, and may be the same as or different than the CPE step up size. Alternatively, after a threshold number of consecutive transmissions without being LBT-blocked, UE 106 may be configured to use the default CPE.

UE 106 may receive data representing various CPE parameters, e.g., from sensing server 134 or from another UE, such as UE 136. The CPE parameters may include any or all of the CPE ramp up size, the CPE ramp down size, a maximum CPE ramping size, any of the various thresholds discussed above, or the like. Additionally or alternatively, some or all of the CPE parameters may be fixed in a communication standard. The standard may define a set of values for any or all of the CPE parameters. Sensing server 134 may select one or more CPE parameter values and signal the selected CPE parameter values to UE 106.

In some cases, UE 106 may be out of network coverage. UE 106 may, while out of network coverage, perform sensing to send a transmission of sidelink traffic 132 to UE 130, UE 106 may send a request to nearby UEs (e.g., UE 136) to obtain CPE ramping parameters. When no nearby UEs have the CPE ramping parameters, UE 106 may use default CPE ramping parameters, as defined in standards, or determine the CPE ramping parameters itself. UE 106 may be configured with a priority order in which to determine or receive the CPE parameters. For example, a highest priority may be to receive CPE parameters from sensing server 134. A next highest priority may be to receive CPE parameters from a nearby UE (e.g., UE 136), when the UE has obtained the CPE parameters directly or indirectly from sensing server 134. A next highest priority may be to receive CPE parameters from a nearby UE (e.g., UE 136) that has determined the CPE parameters as default values or by itself. The last priority may be for UE 106 to use default CPE parameter values or by itself.

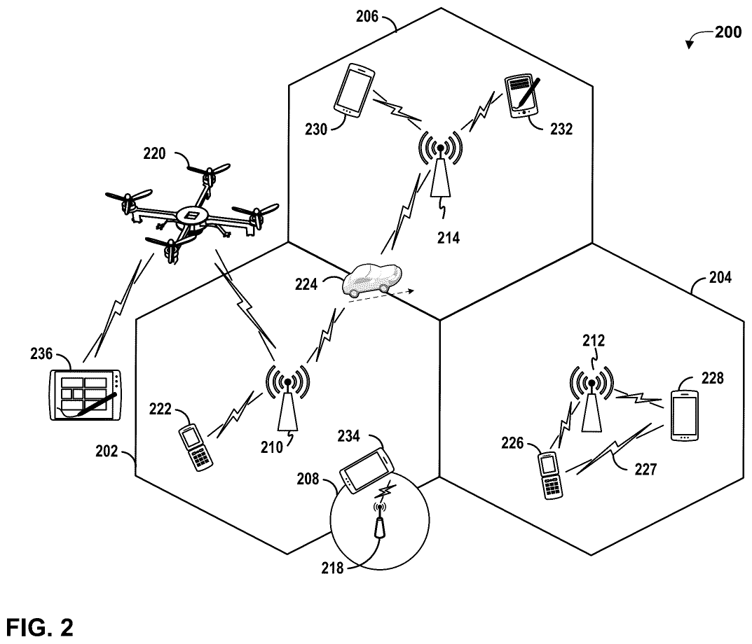

FIG. 2 is a conceptual diagram illustrating an example RAN 200. RAN 200 may correspond to RAN 104 described above and illustrated in FIG. 1. That is, RAN 104 of FIG. 1 may include components similar to or identical to those of RAN 200 of FIG. 2. A geographic area covered by RAN 200 may be divided into cellular regions (cells) that a user equipment (UE) can uniquely identify based on an identification broadcasted from one base station. FIG. 2 illustrates macrocells 202, 204, and 206, and small cell 208.

FIG. 2 depicts base stations 210, 212, and 214 in cells 202, 204, and 206, respectively. In the example of FIG. 2, base stations 210, 212, and 214 support cells having a large size. Therefore, in this example, cells 202, 204, and 206 may be referred to as macrocells. Further, base station 218 is shown in small cell 208 (e.g., a microcell, picocell, femtocell, home base station, home Node B, home eNode B, etc.), which may overlap with one or more macrocells. In this example, base station 218 supports a cell having a relatively small size. Thus, cell 208 may be referred to as a small cell. Cell sizing can be determined according to system design and/or component constraints.

RAN 200 may include any number of wireless base stations and cells. Further, a RAN may include a relay node to extend the size or coverage area of a given cell. Base stations 210, 212, 214, 218 provide wireless access points to a core network for any number of mobile apparatuses. In some examples, base stations 210, 212, 214, and/or 218 may be the same as one of base stations 108 of FIG. 1.

FIG. 2 further includes drone 220, which may be configured to function as a base station. That is, in some examples, a cell need not necessarily be stationary, and the geographic area of the cell may move according to the location of a mobile base station such as drone 220.

Within RAN 200, each of base stations 210, 212, 214, 218, and 220 may be configured to provide an access point to core network 102 of FIG. 1 for all UEs in the respective cells. For example, UEs 222 and 224 may be in communication with the base station 210; UEs 226 and 228 may be in communication with the base station 212; UEs 230 and 232 may be in communication with the base station 214; UE 234 may be in communication with the base station 218; and UE 236 may be in communication with the mobile base station 220. In some examples, the UEs 222, 224, 226, 228, 230, 232, 234, and/or 236, may include components and perform functionality similar to those of UE 106 of FIG. 1.

Per techniques of this disclosure, UEs 226 and 228 may communicate via sidelink unlicensed (shared) band 227. UEs 226 and 228 may use the techniques of this disclosure to determine a CPE, and ramp up or ramp down the CPE based on whether LBT-blocking occurs. UEs 226 and 228 may obtain CPE parameter values from neighboring UEs or a sensing server (not shown in FIG. 2).

In some examples, a mobile node (e.g., quadcopter 220) may be configured to function as a UE. For example, the quadcopter 220 may operate within cell 202 by communicating with base station 210.

The air interface in the RAN 200 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time utilizing a given resource. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

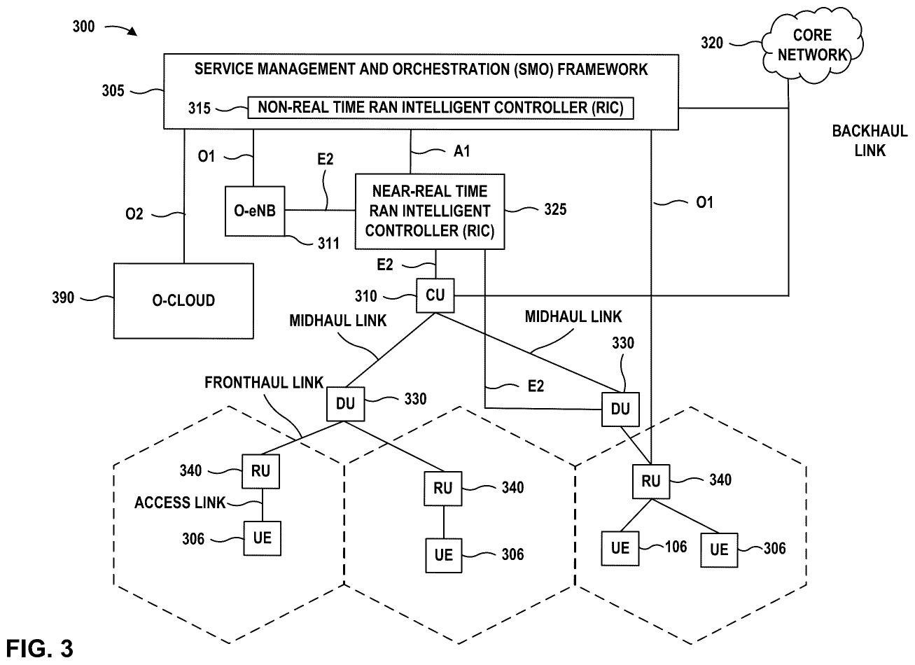

FIG. 3 is a conceptual diagram illustrating an example disaggregated base station 300 architecture. Disaggregated base station 300 architecture may include one or more central units (CUs) 310 that can communicate directly with core network 320 via a backhaul link, or indirectly with core network 320 through one or more disaggregated base station units (such as a Near-Real Time (Near-RT) RAN Intelligent Controller (RIC) 325 via an E2 link, or Non-Real Time (Non-RT) RIC 315 associated with a Service Management and Orchestration (SMO) Framework 305, or both). CU 310 may communicate with one or more distributed units (DUs) 330 via respective midhaul links, such as an F1 interface. DUs 330 may communicate with one or more radio units (RUs) 340 via respective fronthaul links. RUs 340 may communicate with respective UEs 306 via one or more radio frequency (RF) access links. In some implementations, UEs 306 may be simultaneously served by multiple RUs 340.

Each of the units, i.e., CUs 310, DUs 330, RUs 340, UEs 306, Near-RT RICs 325, Non-RT RICs 315, and SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by CU 310. CU 310 may be configured to handle user plane functionality (i.e., Central Unit-User Plane (CU-UP)), control plane functionality (i.e., Central Unit-Control Plane (CU-CP)), or a combination thereof. In some implementations, CU 310 can be logically split into one or more CU-UP units and one or more CU-CP units. The CU-UP unit can communicate bidirectionally with the CU-CP unit via an interface, such as the E1 interface when implemented in an O-RAN configuration. CU 310 can be implemented to communicate with DU 330, as necessary, for network control and signaling.

DU 330 may correspond to a logical unit that includes one or more base station functions to control the operation of one or more RUs 340. In some aspects, DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, DU 330 may further host one or more low PHY layers. Each layer (or module) can be implemented with an interface configured to communicate signals with other layers (and modules) hosted by DU 330, or with the control functions hosted by CU 310.

Lower-layer functionality can be implemented by one or more RUs 340. In some deployments, RU 340, controlled by DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, RU(s) 340 can be implemented to handle over the air (OTA) communication with one or more UEs 306. In some implementations, real-time and non-real-time aspects of control and user plane communication with RU(s) 340 can be controlled by corresponding DU 330. In some scenarios, this configuration can enable DU(s) 330 and CU 310 to be implemented in a cloud-based RAN architecture, such as a vRAN architecture.

SMO Framework 305 may be configured to support RAN deployment and provisioning of non-virtualized and virtualized network elements. For non-virtualized network elements, SMO Framework 305 may be configured to support the deployment of dedicated physical resources for RAN coverage requirements which may be managed via an operations and maintenance interface (such as an O1 interface). For virtualized network elements, SMO Framework 305 may be configured to interact with a cloud computing platform (such as open cloud (O-Cloud) 390) to perform network element life cycle management (such as to instantiate virtualized network elements) via a cloud computing platform interface (such as O2 interface). Such virtualized network elements can include, but are not limited to, CUs 310, DUs 330, RUs 340 and Near-RT RICs 325. In some implementations, SMO Framework 305 can communicate with a hardware aspect of a 4G RAN, such as open eNB (O-eNB) 311, via an O1 interface. Additionally, in some implementations, SMO Framework 305 can communicate directly with one or more RUs 340 via an O1 interface. SMO Framework 305 also may include a Non-RT RIC 315 configured to support functionality of SMO Framework 305.

Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in Near-RT RIC 325. Non-RT RIC 315 may be coupled to or communicate with (such as via an A1 interface) Near-RT RIC 325. Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with Near-RT RIC 325.

In some implementations, to generate AI/ML models to be deployed in Near-RT RIC 325, Non-RT RIC 315 may receive parameters or external enrichment information from external servers. Such information may be utilized by Near-RT RIC 325 and may be received at SMO Framework 305 or Non-RT RIC 315 from non-network data sources or from network functions. In some examples, Non-RT RIC 315 or Near-RT RIC 325 may be configured to tune RAN behavior or performance. For example, Non-RT RIC 315 may monitor long-term trends and patterns for performance and employ AI/ML models to perform corrective actions through SMO Framework 305 (such as reconfiguration via O1) or via creation of RAN management policies (such as A1 policies).

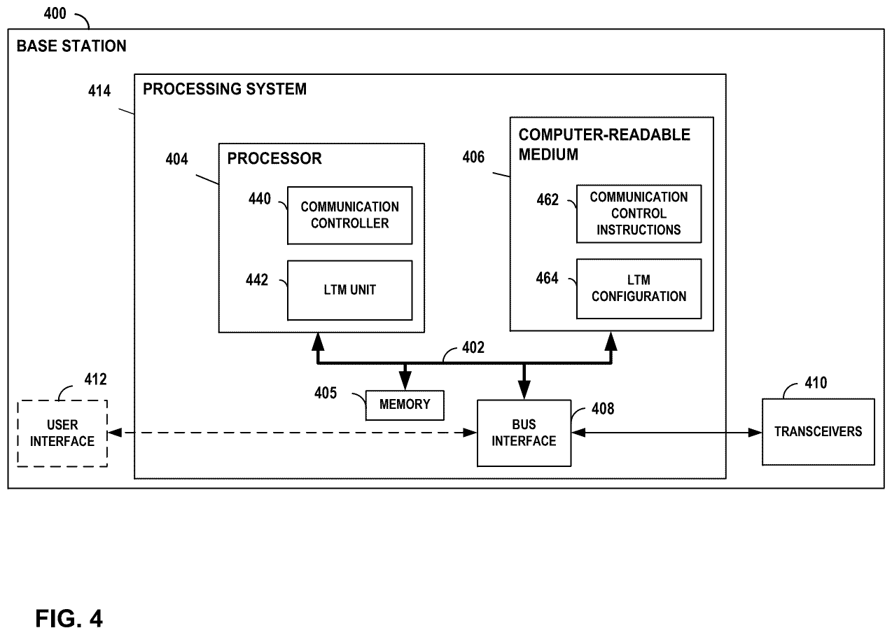

FIG. 4 is a block diagram illustrating an example hardware implementation of base station 400 employing processing system 414. For example, base station 400 may be a base station as illustrated in any of FIGS. 1, 2, and/or 3.

Base station 400, which may also be referred to as a “network node,” may include processing system 414 having one or more processors 404. Processors 404 may be implemented in circuitry. Examples of processors 404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, base station 400 may be configured to perform any one or more of the functions described herein. For example, processor 404, as utilized in base station 400, may be configured (e.g., in coordination with memory 405) to implement any one or more of the processes and procedures described in this disclosure.

Processing system 414 may include a bus architecture, represented generally by bus 402. Bus 402 may include any number of interconnecting buses and bridges depending on the specific application of processing system 414 and the overall design constraints. Bus 402 communicatively couples together various circuits including one or more processors (represented generally by processor 404), memory 405, and computer-readable media (represented generally by computer-readable medium 406). Bus 402 may also link various other circuits such as timing sources, peripherals, voltage regulators, and power management circuits, which are well known in the art, and therefore, will not be described any further. Bus interface 408 provides an interface between bus 402 and transceivers 410. Transceivers 410 provide respective network interfaces, communication interfaces, or other means for communicating with various other apparatus over a transmission medium. Each of transceivers 410 may provide one or more cells or cell groups. For example, each of transceivers 410 may represent radio units (RUs) of base station 400, which may communicate with respective central units (CUs) and distributed units (DUs). Depending upon the nature of the apparatus, user interface 412 (e.g., keypad, display, speaker, microphone, and/or joystick) may also be provided. User interface 412 is optional, and some in examples, certain devices, such as a base station, may omit user interface 412.

In some examples, processor 404 may include communication controller 440 configured (e.g., in coordination with memory 405) for various functions, including, e.g., transmitting and/or receiving user data and/or control signaling to/from a wireless UE. Processor 404 is generally responsible for managing bus 402 and general processing, including the execution of software stored on computer-readable medium 406. The software, when executed by processor 404, causes processing system 414 to perform the various functions described below for any particular apparatus. Processor 404 may also use computer-readable medium 406 and memory 405 for storing data that processor 404 manipulates when executing software.

One or more processors 404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium 406. The computer-readable medium 406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. Additionally or alternatively, computer-readable medium 406 may be formed by any of a variety of memory devices, such as dynamic random access memory (DRAM), including synchronous DRAM (SDRAM), magnetoresistive RAM (MRAM), resistive RAM (RRAM), or other types of memory devices.

Computer-readable medium 406 may reside in processing system 414, external to processing system 414, or distributed across multiple entities including processing system 414. Computer-readable medium 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, computer-readable storage medium 406 may store computer-executable code that includes communication control instructions 462 that configure base station 400 for various functions, including, e.g., transmitting and/or receiving user data and/or control signaling to/from a wireless UE. Circuitry discussed above as being included in processor 404 is merely provided as an example, and other means for carrying out the described functions may be included within various aspects of the present disclosure, including but not limited to the instructions stored in computer-readable storage medium 406, or any other suitable apparatus or means described in any one of the FIGS. 1, 2, and/or 3.

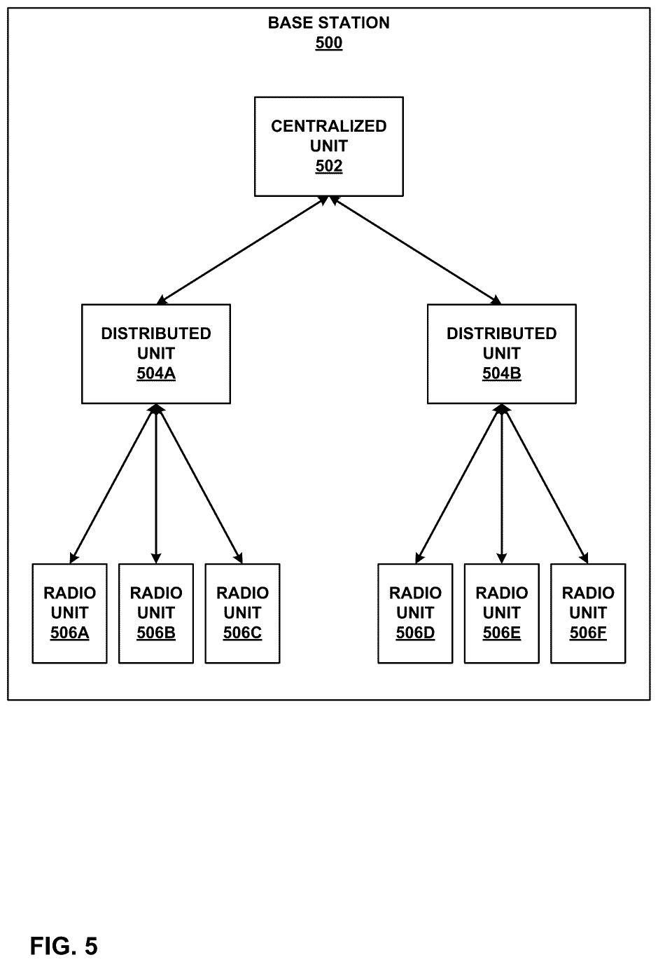

FIG. 5 is a block diagram illustrating an example set of transmission components of base station 500. In general, base station 500 may include components similar to those of base station 400 of FIG. 4. In addition, as shown in FIG. 5, base station 500 includes centralized unit (CU) 502, distributed units (DUs) 504A, 504B, and radio units (RUs) 506A-506F. CU 502, DUs 504, and RUs 506 may generally correspond to transceivers 410 of FIG. 4.

In general, each of RUs 506 may process physical layer/L1 data in radio signals over cells or cell groups, and convert between such radio signals and digital signals for computer-based packet networks. Each of RUs may serve a particular cell or cell group, e.g., performing beam forming. As shown in FIG. 5, multiple RUs may communicate with a single DU. For example, DU 504A is communicatively coupled to each of RUs 506A-506C. Likewise, DU 504B is communicatively coupled to RUs 506D-506F. In practice, there may be more DUs and/or RUs for a given base station.

DUs 504 correspond to a distributed software unit. Each of DUs 504 may execute radio link controllers for respective RUs 340. DUs 504 may also process media access control (MAC)/L2 data, and in some cases, certain parts of the physical/L1 data.

CU 502 may provide user plane functions (UPFs), which may generally process network data at and above the network layer/L3. For example, CU 502 may perform routing and forwarding functions for packets sent to and from base station 500 via respective cells and/or via a backhaul, such as backhaul portion 120 of FIG. 1.

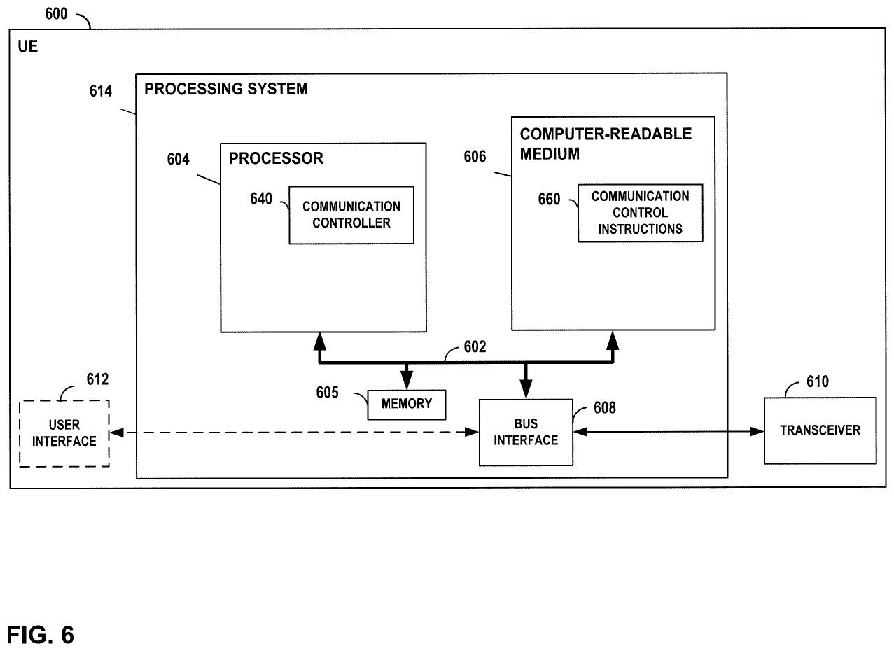

FIG. 6 is a block diagram illustrating an example hardware implementation of an example UE 600 employing processing system 614. UE 600 may be referred to as a “network node.” In some examples, a single device or network node may include functionality of both a UE and a base station as discussed with respect to FIGS. 4 and 6. In accordance with various aspects of this disclosure, processing system 614 may include an element, or any portion of an element, or any combination of elements, having one or more processors 604. For example, any of the various UEs illustrated in and described with respect to FIGS. 1, 2, and/or 3 may include components similar to those of UE 600 of FIG. 6.

Processing system 614 may be substantially the same as processing system 414 of FIG. 4. In the example of FIG. 6, processing system 614 includes bus interface 608, bus 602, memory 605, processor 604, and computer-readable medium 606. Computer-readable medium 406 may be formed by any of a variety of memory devices, such as dynamic random access memory (DRAM), including synchronous DRAM (SDRAM), magnetoresistive RAM (MRAM), resistive RAM (RRAM), hard disks, flash memory, read only memory (ROM), or other types of memory devices. Furthermore, UE 600 may include user interface 612 and transceiver 610, which may be substantially similar to user interface 412 and transceiver 410 as described above with respect to FIG. 4.

In some examples, transceiver 610 may include multiple antenna panels, each such antenna panel having an associated local oscillator. However, transceiver 610 may include any suitable number of antenna panels. In further examples, transceiver 610 may include multiple power amplifiers that can be configured in accordance with the RRC parameter ptrs-Power. For example, transceiver 610 may include a plurality of power amplifiers that, in some examples, may be configured for a “small” or “large” functionality. Here, a “small” power amplifier configuration indicates that the full power that each power amplifier can generate is equal to the quantity: (full power for the UE power class)/(number of transmission layers). And a “large” power amplifier configuration indicates that the full power that each power amplifier can generate is equal to the full power for the UE's power class.

Processor 604, as utilized in UE 600, may be configured (e.g., in coordination with the memory 605) to implement any one or more of the techniques of this disclosure.

In some aspects of the disclosure, processor 604 may include communication controller 640 configured (e.g., in coordination with memory 605) for various functions, including, for example, transmitting and/or receiving user data and/or control signaling (including reference signals) to/from a base station.

Computer-readable storage medium 606 may store computer-executable code that includes communication control instructions 660 that configure UE 600 for various functions, including, e.g., transmitting and/or receiving user data and/or control signaling (including reference signals) to/from a base station. Computer-readable storage medium 606 may further store computer-executable code that includes transmission power boost instructions 662 that configure UE 600 for various functions.

Circuitry discussed with respect to processor 604 is merely provided as one example, and other means for carrying out the described functions may be included within various aspects of the present disclosure, including but not limited to the instructions stored in computer-readable storage medium 606, or any other suitable apparatus or means described in any one of FIGS. 1, 2, and/or 3.

Per techniques of this disclosure, processor 604 may be configured to select a first cyclic prefix extension (CPE) for a transmission over a shared sidelink band via transceiver 610. Processor 604 may also perform a listen before talk (LBT) procedure on the shared sidelink band. In response to the LBT procedure, processor 604 may determine that the shared sidelink band is LBT-blocked. In response to the shared sidelink band being LBT-blocked, processor 604 may select a second CPE larger than the first CPE. Processor 604 may perform a subsequent LBT procedure using the second CPE for the transmission. Assuming that the subsequent LBT procedure indicates that the transmission is not LBT-blocked, processor 604 may transmit the second CPE and the transmission over the shared sidelink band via transceiver 610. Alternatively, if the subsequent LBT procedure indicates that the transmission is again LBT-blocked, processor 604 may select a third, larger CPE for another attempt when transmitting the transmission.

Each increase in CPE size may be linear or non-linear. For example, the difference between the second CPE and the first CPE may be the same as the difference between the third CPE and the second CPE. Alternatively, the difference between the second CPE and the first CPE may be larger than the difference between the third CPE and the second CPE. CPE ramping parameters (also referred to herein generally as “CPE parameters”) defining the CPE ramp up size(s) may be stored in, e.g., memory 605 or computer-readable medium 606.

Processor 604 may also be configured to ramp down the CPE when one or more transmissions are performed without encountering LBT-blocking. For example, when processor 604 transmits a sensing signal with CPE ramping without LBT-blocking consecutively X times, processor 604 may trigger CPE ramp down for the next sensing signal transmission occasion. The step size for the CPE ramp down could be linear or non-linear. The step size for the CPE ramp down may be same or different from the step size for the CPE ramp up. Alternatively, when processor 604 transmits a sensing signal with CPE ramping without LBT-blocking consecutively Y times, processor 604 may use the default CPE for the next sensing signal transmission occasion. The values for X and Y and the CPE ramp down may be stored in, e.g., memory 605 or computer-readable medium 606.

In some examples, if processor 604 ramps up the CPE to a maximum CPE ramping-up size and still gets LBT-blocked consecutively Z times, processor 604 may regard this event as sensing failure. This may trigger processor 604 to select a different starting time point later with the same or different periodicity for sensing using SL-U. When processor 604 experiences this sensing failure event, processor 604 wait for a period of time before its next sensing starting point time.

Processor 604 may interact with a sensing server to receive CPE ramping parameters, e.g., CPE ramp up and/or ramp down size values, and/or the X, Y, and Z values discussed above. Additionally or alternatively, these parameters (or default values for these parameters) may be fixed by a communications standard. In some examples, the standard may define a set of possible values and the sensing server or processor 604 may select appropriate values from the standard-defined set of possible values.

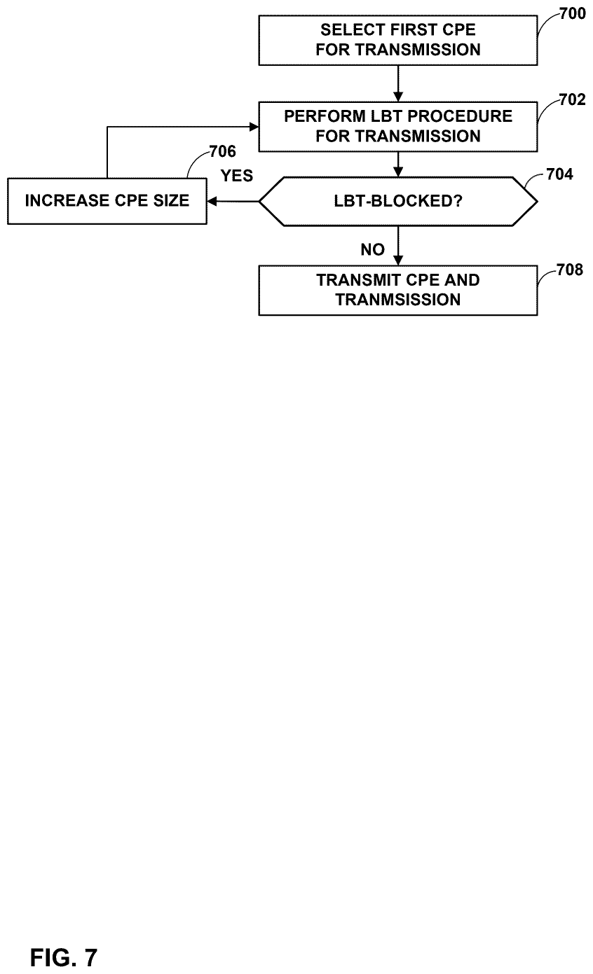

FIG. 7 is a flow diagram illustrating example actions performed by a UE for transmitting over a sidelink channel via a shared (unlicensed) band according to various techniques of this disclosure. The method of FIG. 7 is explained with respect to UE 600 of FIG. 6 for purposes of example. However, this or a similar method may be performed by any of the various UEs of this disclosure, e.g., UE 106 of FIG. 1, UEs 226, 228 of FIG. 2, or UEs 306 of FIG. 3.

Initially, processor 604 of UE 600 may select a first CPE for a transmission (700). The transmission may be a set of data of a communication session that is to be sent over a sidelink channel on a shared (unlicensed) band. After selecting the first CPE, processor 604 may perform a listen before talk (LBT) procedure for the transmission (702). If the LBT procedure indicates that the transmission is LBT-blocked (“YES” branch of 704), processor 604 may increase the CPE size (706) and perform a subsequent LBT procedure for the transmission (702). This may repeat until the transmission is not LBT-blocked (“NO” branch of 704), at which point processor 604 may transmit the determined CPE and the transmission (708). As discussed above, if the CPE reaches a maximum CPE size and/or if the consecutive number of attempted transmissions that are LBT-blocked crosses a threshold, processor 604 may instead determine to either way for a period of time before reattempting transmission or switch to a different channel.

In this manner, the method of FIG. 7 represents an example of a method of wireless communication, including: selecting a first cyclic prefix extension (CPE) for a transmission over a shared sidelink band; performing a listen before talk (LBT) procedure on the shared sidelink band; in response to the LBT procedure, determining that the shared sidelink band is LBT-blocked; in response to the shared sidelink band being LBT-blocked, selecting a second CPE larger than the first CPE; and transmitting the second CPE and the transmission over the shared sidelink band.

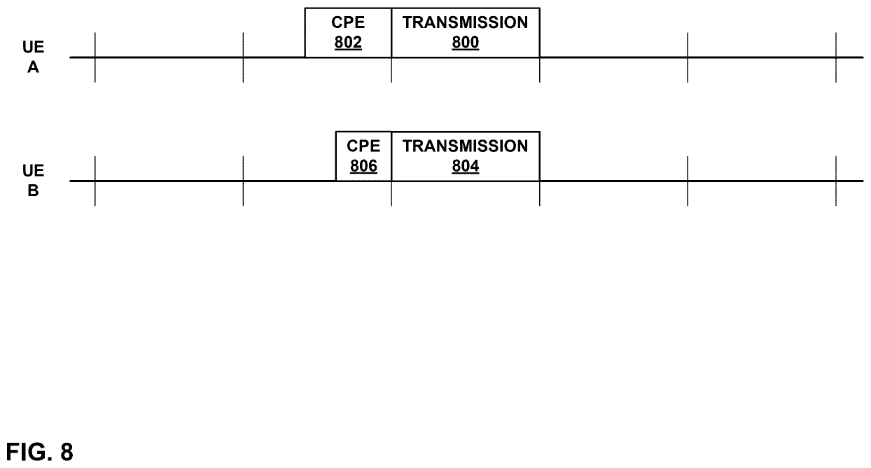

FIG. 8 is a conceptual diagram illustrating the use of CPEs to access a sidelink channel on a shared (unlicensed) band. In this example, UE A has scheduled transmission 800 at the same time that UE B has scheduled transmission 804. UE A selects CPE 802, whereas UE B selects CPE 806. As shown in the example of FIG. 8, CPE 802 is larger than CPE 806. Therefore, when UE A performs a LBT procedure, UE A determines that the band is not currently in use and can transmit both CPE 802 and transmission 800. UE B will then perform a LBT procedure and determine that the band is in use before transmitting CPE 806 and transmission 804.

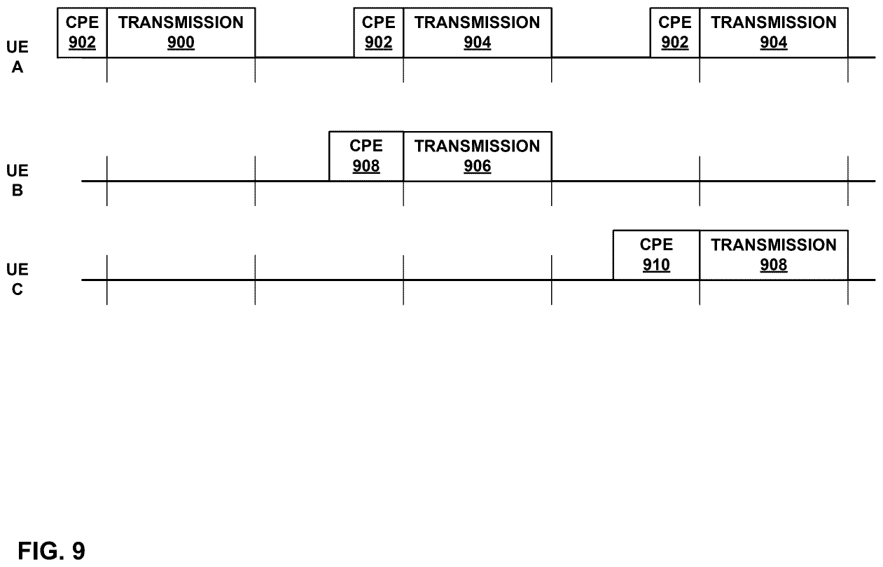

FIG. 9 is a conceptual diagram illustrating another example use of CPEs to access a sidelink channel on a shared (unlicensed) band. In this example, initially, UE A schedules transmission 900 for an occasion and selects CPE 902 for transmission 900. No other UE uses the band at this occasion (that is, there is no LBT-blocking), so UE A is able to transmit CPE 902 and transmission 900 successfully. At a later occasion, UE A determines that transmission 904 is LBT-blocked by transmission 906 and CPE 908 from UE B. Thus, UE A reattempts transmission of CPE 902 and transmission 904 at a later occasion, but determines that this is again LBT-blocked, this time by CPE 910 and transmission 908 from UE C. Due to the blockage of the sensing signals transmitted by UE A, the sensing performance may be degraded.

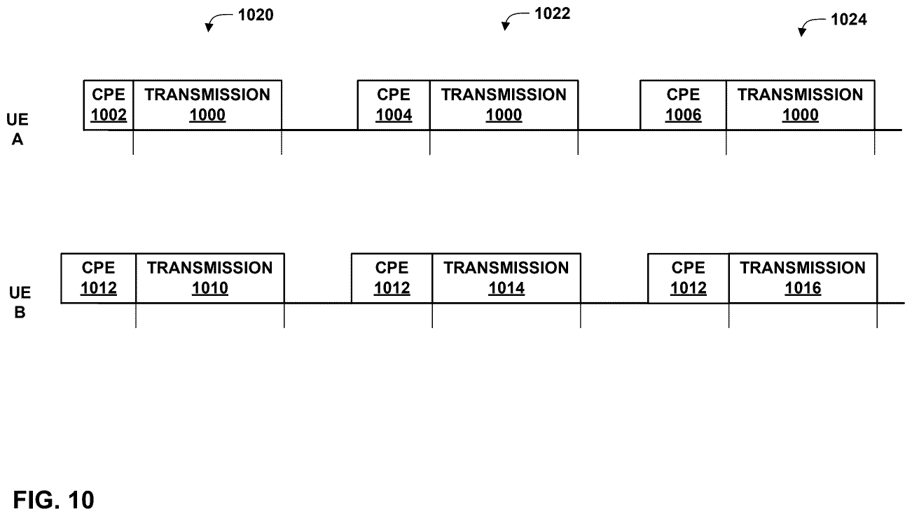

FIG. 10 is a conceptual diagram illustrating an example CPE ramping procedure per techniques of this disclosure. In this example, UE A attempts transmission 1000 with CPE 1002 at occasion 1020. However, UE B performs transmission 1010 at occasion 1020 including CPE 1012, and CPE 1012 is larger than CPE 1002. Therefore, for occasion 1020, UE A would detect LBT-blocking and would avoid transmitting.

For occasion 1022, UE A would select CPE 1004, which is larger than CPE 1002, for transmission 1000. However, once again in this example, UE B has selected CPE 1012 for transmission 1014, which is also larger than CPE 1004. Thus, again, UE A would detect LBT-blocking for occasion 1022 and would avoid transmitting.

In this example, UE A selects an even larger CPE 1006 for transmission 1000 at occasion 1024. In this case, CPE 1006 is larger than CPE 1012 selected by UE B for transmission 1016. Therefore, UE A will not detect LBT-blocking, and proceed to transmit CPE 1006 and transmission 1000. Meanwhile, per techniques of this disclosure, UE B may select a larger CPE size for a subsequent transmission (not shown in FIG. 10).

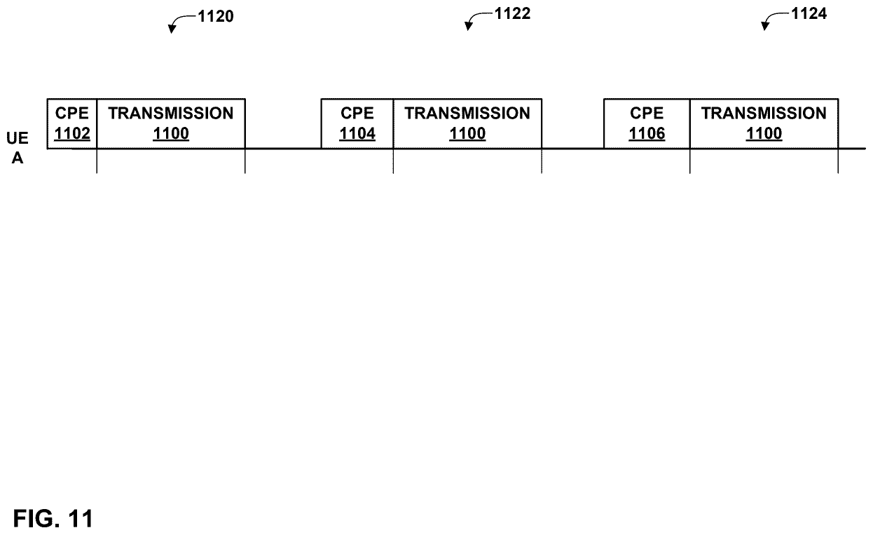

FIG. 11 is a conceptual diagram illustrating an example maximum CPE ramping-up size and sensing failure. In this example, UE A selects CPE 1102 for transmission 1100 at occasion 1120. In this case, UE A may detect LBT-blocking for occasion 1120, and thus avoid transmitting. UE A may then select CPE 1104, which is larger than CPE 1102, for occasion 1122. However, UE A may once again determine that occasion 1122 is LBT-blocked. Thus, UE A may select CPE 1106, which is larger than CPE 1104, for occasion 1124, but once again determine that occasion 1124 is LBT-blocked. After a certain number (e.g., Z) attempts that are consecutively LBT-blocked, UE A may elect to wait for a certain period of time before reattempting transmission 1100. After the period of time, UE A may attempt transmission with the default CPE (e.g., CPE 1102).

Various examples of the techniques of this disclosure are summarized in the following clauses:
Clause 1: A user equipment (UE) device for wireless communication comprising: a communication interface; and a processing system coupled to the communication interface, wherein the processing system is configured to: select a first cyclic prefix extension (CPE) for a transmission over a shared sidelink band via the communication interface; perform a listen before talk (LBT) procedure on the shared sidelink band; in response to the LBT procedure, determine that the shared sidelink band is LBT-blocked; in response to the shared sidelink band being LBT-blocked, select a second CPE larger than the first CPE; and transmit the second CPE and the transmission over the shared sidelink band via the communication interface.
Clause 2: The UE device of clause 1, wherein the first CPE is larger than an earlier CPE for the transmission by a linear step size, and wherein the second CPE is larger than the first CPE by the linear step size.
Clause 3: The UE device of clause 1, wherein the first CPE is larger than an earlier CPE for the transmission by a first step size, and wherein the second CPE is larger than the first CPE by a second step size that is larger than the first step size.
Clause 4: The UE device of clause 1, wherein the processing system is configured to use the second CPE for one or more subsequent transmissions to the transmission until a period of time without detection of one or more LBT-blocks has exceeded a threshold.
Clause 5: The UE device of clause 4, wherein the processing system is configured to select a third CPE smaller than the second CPE for a transmission following the period of time without detection of the one or more LBT-blocks that exceeds the threshold.
Clause 6: The UE device of clause 5, wherein the third CPE is equal to the first CPE.
Clause 7: The UE device of clause 5, wherein the third CPE is smaller than the first CPE.
Clause 8: The UE device of clause 1, wherein the transmission comprises a first transmission, and wherein the processing system is further configured to, after a threshold number of LBT-blocked attempts to transmit a second transmission having a largest CPE, delay the second transmission for a predefined waiting period.
Clause 9: The UE device of clause 1, wherein the processing system is configured to receive, from a sensing server, CPE ramping parameters including one or more of a CPE ramping up size, a CPE ramping down size, or a maximum CPE ramping size.
Clause 10: The UE device of clause 1, wherein the processing system is configured to receive, from a nearby user equipment (UE) device, CPE ramping parameters including one or more of a CPE ramping up size, a CPE ramping down size, or a maximum CPE ramping size.
Clause 11: The UE device of clause 1, wherein the processing system is configured to: when a sensing server is available, receive CPE ramping parameters, including one or more of a CPE ramping up size, a CPE ramping down size, or a maximum CPE ramping size, from the sensing server; when the sensing server is not available and a nearby user equipment (UE) device is available and has received the CPE ramping parameters from the sensing server, receive the CPE ramping parameters from the UE; when the sensing server is not available, the nearby UE is available, and the nearby UE has not received the CPE ramping parameters from the sensing server but the nearby UE has determined the CPE ramping parameters, receive the CPE ramping parameters from the UE; or when the sensing server is not available and the nearby UE has not obtained the CPE ramping parameters, determine the CPE ramping parameters.
Clause 12: A method of wireless communication comprising: selecting a first cyclic prefix extension (CPE) for a transmission over a shared sidelink band; performing a listen before talk (LBT) procedure on the shared sidelink band; in response to the LBT procedure, determining that the shared sidelink band is LBT-blocked; in response to the shared sidelink band being LBT-blocked, selecting a second CPE larger than the first CPE; and transmitting the second CPE and the transmission over the shared sidelink band.
Clause 13: The method of clause 12, wherein the first CPE is larger than an earlier CPE for the transmission by a linear step size, and wherein the second CPE is larger than the first CPE by the linear step size.
Clause 14: The method of clause 12, wherein the first CPE is larger than an earlier CPE for the transmission by a first step size, and wherein the second CPE is larger than the first CPE by a second step size that is larger than the first step size.
Clause 15: The method of clause 12, further comprising using the second CPE for one or more subsequent transmissions to the transmission until a period of time without detection of one or more LBT-blocks has exceeded a threshold.
Clause 16: The method of clause 15, further comprising selecting a third CPE smaller than the second CPE for a transmission following the period of time without detection of the one or more LBT-blocks that exceeds the threshold.
Clause 17: The method of clause 16, wherein the third CPE is equal to or smaller than the first CPE.
Clause 18: The method of clause 12, wherein the transmission comprises a first transmission, the method further comprising, after a threshold number of LBT-blocked attempts to transmit a second transmission having a largest CPE, delaying the second transmission for a predefined waiting period.
Clause 19: The method of clause 12, further comprising: when a sensing server is available, receiving CPE ramping parameters, including one or more of a CPE ramping up size, a CPE ramping down size, or a maximum CPE ramping size, from the sensing server; when the sensing server is not available and a nearby user equipment (UE) device is available and has received the CPE ramping parameters from the sensing server, receiving the CPE ramping parameters from the UE; when the sensing server is not available, the nearby UE is available, and the nearby UE has not received the CPE ramping parameters from the sensing server but the nearby UE has determined the CPE ramping parameters, receiving the CPE ramping parameters from the UE; or when the sensing server is not available and the nearby UE has not obtained the CPE ramping parameters, determining the CPE ramping parameters.
Clause 20: A user equipment (UE) device for wireless communication comprising: means for selecting a first cyclic prefix extension (CPE) for a transmission over a shared sidelink band; means for performing a listen before talk (LBT) procedure on the shared sidelink band; means for determining, in response to the LBT procedure, that the shared sidelink band is LBT-blocked; means for selecting, in response to the shared sidelink band being LBT-blocked, a second CPE larger than the first CPE; and means for transmitting the second CPE and the transmission over the shared sidelink band.
Clause 21: A UE device for wireless communication comprising: a communication interface; and a processing system coupled to the communication interface, wherein the processing system is configured to: select a first cyclic prefix extension (CPE) for a transmission over a shared sidelink band via the communication interface; perform a listen before talk (LBT) procedure on the shared sidelink band; in response to the LBT procedure, determine that the shared sidelink band is LBT-blocked; in response to the shared sidelink band being LBT-blocked, select a second CPE larger than the first CPE; and transmit the second CPE and the transmission over the shared sidelink band via the communication interface.
Clause 22: The UE device of clause 21, wherein the first CPE is larger than an earlier CPE for the transmission by a linear step size, and wherein the second CPE is larger than the first CPE by the linear step size.
Clause 23: The UE device of clause 21, wherein the first CPE is larger than an earlier CPE for the transmission by a first step size, and wherein the second CPE is larger than the first CPE by a second step size that is larger than the first step size.
Clause 24: The UE device of any of clauses 21-23, wherein the processing system is configured to use the second CPE for one or more subsequent transmissions to the transmission until a period of time without detection of one or more LBT-blocks has exceeded a threshold.
Clause 25: The UE device of clause 24, wherein the processing system is configured to select a third CPE smaller than the second CPE for a transmission following the period of time without detection of the one or more LBT-blocks that exceeds the threshold.
Clause 26: The UE device of clause 25, wherein the third CPE is equal to the first CPE.
Clause 27: The UE device of clause 25, wherein the third CPE is smaller than the first CPE.
Clause 28: The UE device of any of clauses 21-27, wherein the transmission comprises a first transmission, and wherein the processing system is further configured to, after a threshold number of LBT-blocked attempts to transmit a second transmission having a largest CPE, delay the second transmission for a predefined waiting period.
Clause 29: The UE device of any of clauses 21-28, wherein the processing system is configured to receive, from a sensing server, CPE ramping parameters including one or more of a CPE ramping up size, a CPE ramping down size, or a maximum CPE ramping size.
Clause 30: The UE device of any of clauses 21-28, wherein the processing system is configured to receive, from a nearby user equipment (UE) device, CPE ramping parameters including one or more of a CPE ramping up size, a CPE ramping down size, or a maximum CPE ramping size.
Clause 31: The UE device of any of clauses 21-28, wherein the processing system is configured to: when a sensing server is available, receive CPE ramping parameters, including one or more of a CPE ramping up size, a CPE ramping down size, or a maximum CPE ramping size, from the sensing server; when the sensing server is not available and a nearby user equipment (UE) device is available and has received the CPE ramping parameters from the sensing server, receive the CPE ramping parameters from the UE; when the sensing server is not available, the nearby UE is available, and the nearby UE has not received the CPE ramping parameters from the sensing server but the nearby UE has determined the CPE ramping parameters, receive the CPE ramping parameters from the UE; or when the sensing server is not available and the nearby UE has not obtained the CPE ramping parameters, determine the CPE ramping parameters.
Clause 32: A method of wireless communication comprising: selecting a first cyclic prefix extension (CPE) for a transmission over a shared sidelink band; performing a listen before talk (LBT) procedure on the shared sidelink band; in response to the LBT procedure, determining that the shared sidelink band is LBT-blocked; in response to the shared sidelink band being LBT-blocked, selecting a second CPE larger than the first CPE; and transmitting the second CPE and the transmission over the shared sidelink band.
Clause 33: The method of clause 32, wherein the first CPE is larger than an earlier CPE for the transmission by a linear step size, and wherein the second CPE is larger than the first CPE by the linear step size.
Clause 34: The method of clause 32, wherein the first CPE is larger than an earlier CPE for the transmission by a first step size, and wherein the second CPE is larger than the first CPE by a second step size that is larger than the first step size.
Clause 35: The method of any of clauses 32-34, further comprising using the second CPE for one or more subsequent transmissions to the transmission until a period of time without detection of one or more LBT-blocks has exceeded a threshold.
Clause 36: The method of clause 35, further comprising selecting a third CPE smaller than the second CPE for a transmission following the period of time without detection of the one or more LBT-blocks that exceeds the threshold.
Clause 37: The method of clause 36, wherein the third CPE is equal to or smaller than the first CPE.
Clause 38: The method of any of clauses 32-37, wherein the transmission comprises a first transmission, the method further comprising, after a threshold number of LBT-blocked attempts to transmit a second transmission having a largest CPE, delaying the second transmission for a predefined waiting period.
Clause 39: The method of any of clauses 32-38, further comprising: when a sensing server is available, receiving CPE ramping parameters, including one or more of a CPE ramping up size, a CPE ramping down size, or a maximum CPE ramping size, from the sensing server; when the sensing server is not available and a nearby user equipment (UE) device is available and has received the CPE ramping parameters from the sensing server, receiving the CPE ramping parameters from the UE; when the sensing server is not available, the nearby UE is available, and the nearby UE has not received the CPE ramping parameters from the sensing server but the nearby UE has determined the CPE ramping parameters, receiving the CPE ramping parameters from the UE; or when the sensing server is not available and the nearby UE has not obtained the CPE ramping parameters, determining the CPE ramping parameters.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A user equipment (UE) device for wireless communication comprising:
a communication interface; and
a processing system coupled to the communication interface, wherein the processing system is configured to:
select a first cyclic prefix extension (CPE) for a transmission over a shared sidelink band via the communication interface;
perform a listen before talk (LBT) procedure on the shared sidelink band;
in response to the LBT procedure, determine that the shared sidelink band is LBT-blocked;
in response to the shared sidelink band being LBT-blocked, select a second CPE larger than the first CPE; and
transmit the second CPE and the transmission over the shared sidelink band via the communication interface.

2. The UE device of claim 1, wherein the first CPE is larger than an earlier CPE for the transmission by a linear step size, and wherein the second CPE is larger than the first CPE by the linear step size.

3. The UE device of claim 1, wherein the first CPE is larger than an earlier CPE for the transmission by a first step size, and wherein the second CPE is larger than the first CPE by a second step size that is larger than the first step size.

4. The UE device of claim 1, wherein the processing system is configured to use the second CPE for one or more subsequent transmissions to the transmission until a period of time without detection of one or more LBT-blocks has exceeded a threshold.

5. The UE device of claim 4, wherein the processing system is configured to select a third CPE smaller than the second CPE for a transmission following the period of time without detection of the one or more LBT-blocks that exceeds the threshold.

6. The UE device of claim 5, wherein the third CPE is equal to the first CPE.

7. The UE device of claim 5, wherein the third CPE is smaller than the first CPE.

8. The UE device of claim 1, wherein the transmission comprises a first transmission, and wherein the processing system is further configured to, after a threshold number of LBT-blocked attempts to transmit a second transmission having a largest CPE, delay the second transmission for a predefined waiting period.

9. The UE device of claim 1, wherein the processing system is configured to receive, from a sensing server, CPE ramping parameters including one or more of a CPE ramping up size, a CPE ramping down size, or a maximum CPE ramping size.

10. The UE device of claim 1, wherein the processing system is configured to receive, from a nearby user equipment (UE) device, CPE ramping parameters including one or more of a CPE ramping up size, a CPE ramping down size, or a maximum CPE ramping size.

11. The UE device of claim 1, wherein the processing system is configured to:
when a sensing server is available, receive CPE ramping parameters, including one or more of a CPE ramping up size, a CPE ramping down size, or a maximum CPE ramping size, from the sensing server;
when the sensing server is not available and a nearby user equipment (UE) device is available and has received the CPE ramping parameters from the sensing server, receive the CPE ramping parameters from the UE;
when the sensing server is not available, the nearby UE is available, and the nearby UE has not received the CPE ramping parameters from the sensing server but the nearby UE has determined the CPE ramping parameters, receive the CPE ramping parameters from the UE; or
when the sensing server is not available and the nearby UE has not obtained the CPE ramping parameters, determine the CPE ramping parameters.

12. A method of wireless communication comprising:
selecting a first cyclic prefix extension (CPE) for a transmission over a shared sidelink band;
performing a listen before talk (LBT) procedure on the shared sidelink band;
in response to the LBT procedure, determining that the shared sidelink band is LBT-blocked;
in response to the shared sidelink band being LBT-blocked, selecting a second CPE larger than the first CPE; and
transmitting the second CPE and the transmission over the shared sidelink band.

13. The method of claim 12, wherein the first CPE is larger than an earlier CPE for the transmission by a linear step size, and wherein the second CPE is larger than the first CPE by the linear step size.

14. The method of claim 12, wherein the first CPE is larger than an earlier CPE for the transmission by a first step size, and wherein the second CPE is larger than the first CPE by a second step size that is larger than the first step size.

15. The method of claim 12, further comprising using the second CPE for one or more subsequent transmissions to the transmission until a period of time without detection of one or more LBT-blocks has exceeded a threshold.

16. The method of claim 15, further comprising selecting a third CPE smaller than the second CPE for a transmission following the period of time without detection of the one or more LBT-blocks that exceeds the threshold.

17. The method of claim 16, wherein the third CPE is equal to or smaller than the first CPE.

18. The method of claim 12, wherein the transmission comprises a first transmission, the method further comprising, after a threshold number of LBT-blocked attempts to transmit a second transmission having a largest CPE, delaying the second transmission for a predefined waiting period.

19. The method of claim 12, further comprising:
when a sensing server is available, receiving CPE ramping parameters, including one or more of a CPE ramping up size, a CPE ramping down size, or a maximum CPE ramping size, from the sensing server;
when the sensing server is not available and a nearby user equipment (UE) device is available and has received the CPE ramping parameters from the sensing server, receiving the CPE ramping parameters from the UE;
when the sensing server is not available, the nearby UE is available, and the nearby UE has not received the CPE ramping parameters from the sensing server but the nearby UE has determined the CPE ramping parameters, receiving the CPE ramping parameters from the UE; or
when the sensing server is not available and the nearby UE has not obtained the CPE ramping parameters, determining the CPE ramping parameters.

20. A user equipment (UE) device for wireless communication comprising:
means for selecting a first cyclic prefix extension (CPE) for a transmission over a shared sidelink band;
means for performing a listen before talk (LBT) procedure on the shared sidelink band;
means for determining, in response to the LBT procedure, that the shared sidelink band is LBT-blocked;
means for selecting, in response to the shared sidelink band being LBT-blocked, a second CPE larger than the first CPE; and
means for transmitting the second CPE and the transmission over the shared sidelink band.
